(19) United States
(12) Patent Application Publication
(10) Pub. No.: US 2013/0034834 A1
(43) Pub. Date: Feb. 7, 2013

(54) ELECTRONIC DEVICE AND METHOD FOR SIMULATING FLIGHT OF UNMANNED AERIAL VEHICLE

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/484,286

(22) Filed: May 31, 2012

(30) Foreign Application Priority Data
Aug. 1, 2011 (TW) 100127291

(51) Int. Cl. G09B 9/08

(52) U.S. Cl. 434/45

(57) ABSTRACT

A method for simulating flight operations of an unmanned aerial vehicle (UAV) using an electronic device obtains movement data of the electronic device detected by an accelerator sensor of the electronic device, and converts the movement data of the electronic device into control signals. The method further adjusts the control signals using a physics engine of the electronic device, and simulates flight operations of the UAV by controlling flight statuses of a three dimensional (3D) virtual UAV in a 3D virtual scene on a display screen of the electronic device according to the adjusted control signals.

### BACKGROUND

1. Technical Field

Embodiments of the present disclosure relate to helicopter control technology, and particularly to an electronic device and method for simulating flight operations of an unmanned aerial vehicle (UAV) using the electronic device.

2. Description of Related Art

UAVs have been used to perform security surveillance by capturing images of a number of monitored scenes, and sending the captured images to a monitoring computer. A flight test of the UAV needs to be controlled using a special controller installed in the monitoring computer. However, the UAV under test may crash or become ineffective due to a false operation on the special controller. Therefore, an efficient method for testing flight operations of the UAV by simulation flights is desired.

### BRIEF DESCRIPTION OF THE DRAWINGS

FIG. 1 is a schematic diagram of one embodiment of an electronic device including an unmanned aerial vehicle (UAV) flight simulating system.

FIG. 2 is a schematic diagram of function modules of the UAV flight simulating system included in the electronic device.

FIG. 3 is a flowchart of one embodiment of a method for simulating flight operations of UAV using the electronic device.

FIG. 4 is a schematic diagram of one embodiment of a three dimensional coordinate system of the electronic device in FIG. 1.

FIG. 5 is a schematic diagram of one embodiment of movement data detected by an accelerator sensor when the electronic device is moving.

FIG. 6 is a schematic diagram of one embodiment of a converting table for converting the movement data of the electronic device to different control signals.

FIG. 7A is a schematic diagram of one embodiment of a movement of the electronic device to generate a first control signal.

FIG. 7B is a schematic diagram of one embodiment of controlling a flight status of a three dimensional (3D) virtual UAV in a 3D virtual scene according to a first adjusted control signal.

FIG. 8A is a schematic diagram of one embodiment of a movement of the electronic device to generate a second control signal.

FIG. 8B is a schematic diagram of one embodiment of controlling a flight status of the 3D virtual UAV in the 3D virtual scene according to a second adjusted control signal.

FIG. 9A is a schematic diagram of one embodiment of a movement of the electronic device to generate a third control signal.

FIG. 9B is a schematic diagram of one embodiment of controlling a flight status of the 3D virtual UAV in the 3D virtual scene according to a third adjusted control signal.

FIG. 10A is a schematic diagram of one embodiment of a movement of the electronic device to generate a fourth control signal.

FIG. 10B is a schematic diagram of one embodiment of controlling a flight status of the 3D virtual UAV in the 3D virtual scene according to a fourth adjusted control signal.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage unit. Some or all of the methods may alternatively be embodied in specialized hardware. Depending on the embodiment, the non-transitory computer-readable medium may be a hard disk drive, a compact disc, a digital video disc, a tape drive or other suitable storage medium.

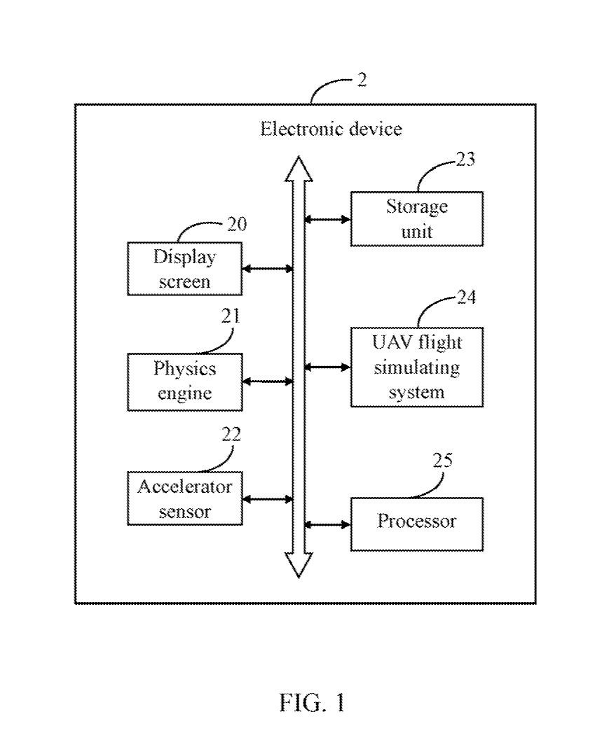

FIG. 1 is a block diagram of one embodiment of an electronic device 2 including an unmanned aerial vehicle (UAV) flight simulating system 24. The electronic device 2 further includes a display screen 20, a physics engine 21, an accelerator sensor 22, a storage unit 23, and at least one processor 25. The electronic device 2 may be a smart phone, a personal digital assistant (PDA), or other computing device. It should be understood that FIG. 1 illustrates only one example of the electronic device 2 that may include more or fewer components than illustrated, or have a different configuration of the various components in other embodiments.

In one embodiment, the display screen 20 may be a liquid crystal display (LCD) or a touch-sensitive display, for example. The physics engine 21 is computer software that provides an approximate simulation of certain physical systems (e.g., rigid body dynamics). For example, the physics engine 21 may be the PhysX software. The accelerator sensor 22 may include, but is not limited to, a two-axis accelerometer, a three-axis accelerometer, a two-axis gyro, and a three-axis gyro.

The UAV flight simulating system 24 obtains data as to the movements (movement data) of the electronic device 2 detected by the accelerator sensor 22, and simulates a flight operation of UAV according to the movement data of the electronic device 2. In one embodiment, the UAV flight simulating system 24 may include computerized instructions in the form of one or more programs that are executed by the at least one processor 25 and stored in the storage unit 23 (or memory). A detailed description of the UAV flight simulating system 24 will be given in the following paragraphs.

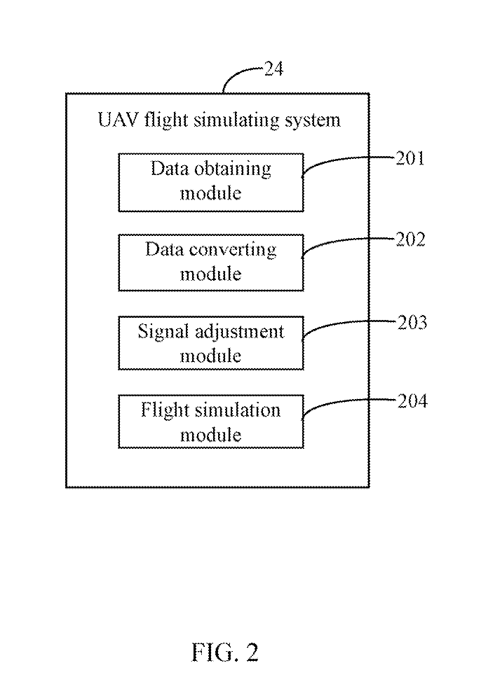

FIG. 2 is a block diagram of function modules of the UAV flight simulating system 24 included in the electronic device 2. In one embodiment, the flight simulating system 24 may include one or more modules, for example, a data obtaining module 201, a data converting module 202, a signal adjustment module 203, and a flight simulation module 204. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

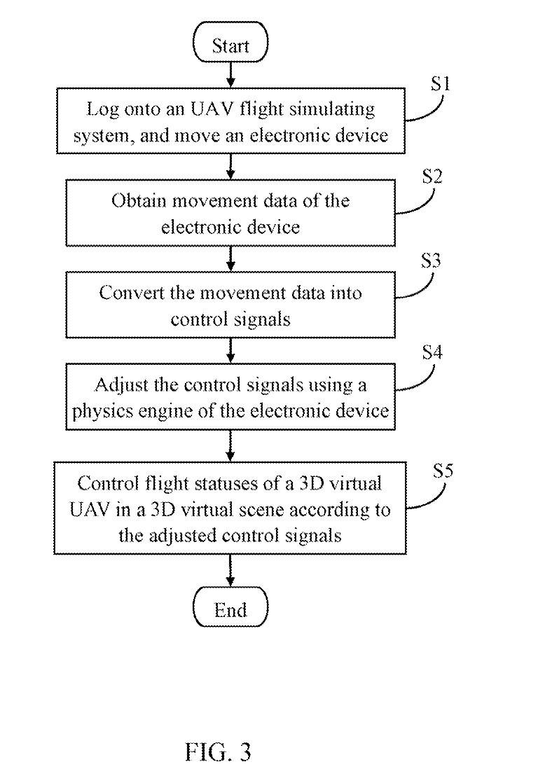

FIG. 3 is a flowchart of one embodiment of a method for simulating flight operations of UAV using the electronic device 2. Depending on the embodiment, additional steps may be added, others removed, and the ordering of the steps may be changed.

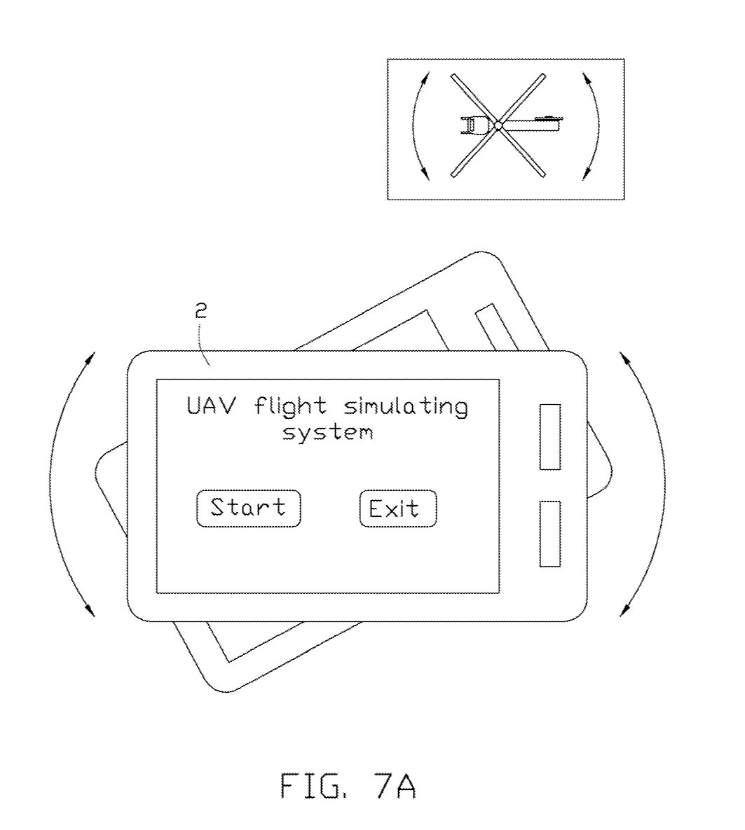

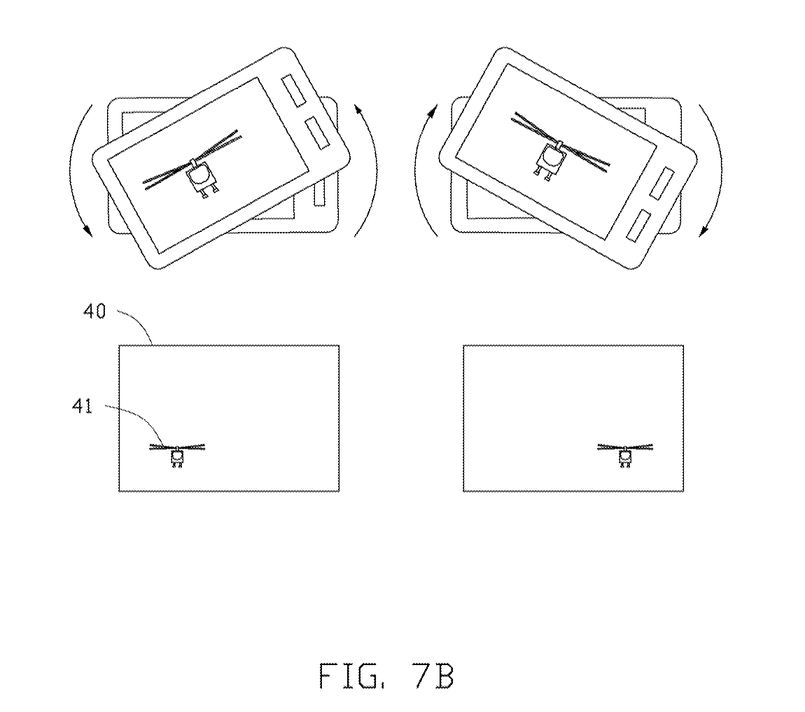

In one embodiment, a three dimensional (3D) virtual scene 40 and a 3D virtual UAV 41 are preset and displayed on the display screen 20 for simulating the flight operations of UAV. As shown in FIG. 7B, the 3D virtual UAV 41 is displayed in the 3D virtual scene 40. The 3D virtual scene 40 and the 3D virtual UAV 41 are drawn using a 3D graphics software (e.g., GOOGLE SketchUp), and set in the physics engine 21. Further, environmental parameters of the 3D virtual scene 40 are also preset by the UAV flight simulating system 24, the 3D virtual scene 40, the 3D virtual UAV 41, and the preset environmental parameters are stored in the storage unit 23. In one embodiment, the preset environmental parameters may include, but are not limited to, quality and a speed of the 3D virtual UAV 41, and a wind speed in the 3D virtual scene 40.

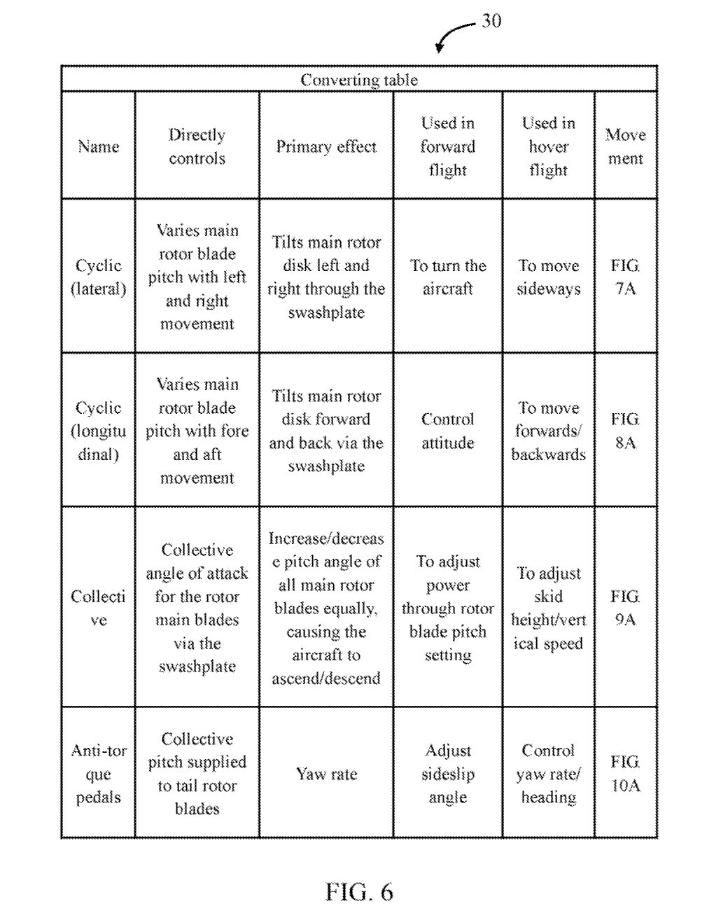

In block S1, a user logs onto the UAV flight simulating system 24, and moves the electronic device 2. In one embodiment, a movement of the electronic device 2 may be a upward movement, a downward movement, a leftward movement, or a rightward movement. In one embodiment, the 3D virtual UAV 41 in this embodiment includes a cyclic control, a collective pitch control, and anti-torque pedals. Detailed descriptions of primary effects of each control on the 3D virtual UAV 41 are shown in FIG. 6.

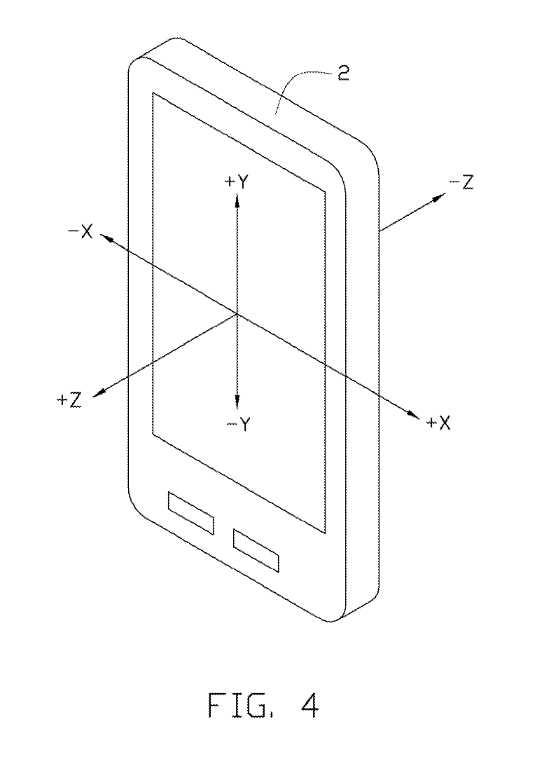

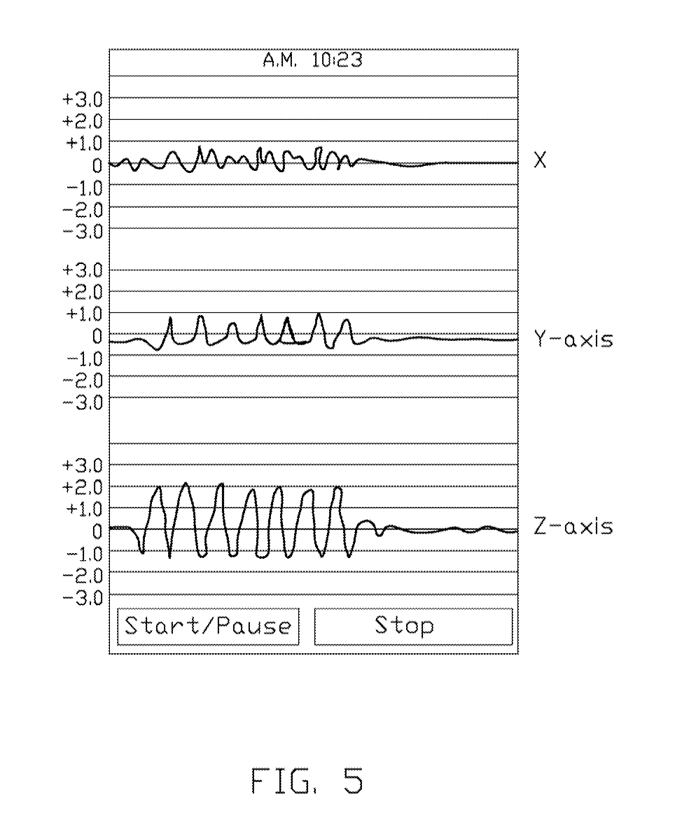

In block S2, the data obtaining module 201 obtains movement data of the electronic device 2 detected by the accelerator sensor 22 of the electronic device 2. Referring to FIG. 4 and FIG. 5, the movement data of the electronic device 2 may include movement directions and movement distances of the electronic device 2 based on a 3D coordinate system (i.e., an X-Y-Z coordinate system). As shown in FIG. 5, the accelerator sensor 22 detects the movement data of the electronic device 2 along X-Y-Z axes of the 3D coordinate system when the electronic device 2 is moved.

In one embodiment, if the movement distance in the X-axis of the electronic device 2 is less than a first preset value (e.g., 0.1 centimeters), the data obtaining module 201 determines that the electronic device 2 has not moved along the X-axis. If the movement distance in the Y-axis of the electronic device 2 is less than a second preset value (e.g., 0.2 centimeters), the data obtaining module 201 determines that the electronic device 2 has not moved along the Y-axis. If the movement distance in the Z-axis of the electronic device 2 is less than a third preset value (e.g., 0.3 centimeters), the data obtaining module 201 determines that the electronic device 2 has not moved along the Z-axis.

In block S3, the data converting module 202 converts the movement data of the electronic device 2 into control signals. In one embodiment, the control signals may include, but are not limited to, a first control signal to control lateral motion of the cyclic control of 3D virtual UAV 41, a second control signal to control longitudinal motion of the cyclic control of 3D virtual UAV 41, a third control signal to control motion of the collective pitch control of 3D virtual UAV 41, and a fourth control signal to control motions of the anti-torque pedals of 3D virtual UAV 41. A converting table 30, as shown in FIG. 6, is used to convert the movement data of the electronic device 2 to different control signals.

In one embodiment, if the electronic device 2 is moved as shown in FIG. 7A, the data converting module 202 converts the movement data of the electronic device 2 into the first control signal. That is to say, if the movement distance in the X-axis of the electronic device 2 is greater than or equal to the first preset value, the movement distance in the Y-axis of the electronic device 2 is greater than or equal to the second preset value, and the movement distance in the Z-axis of the electronic device 2 is less than the third preset value, the data converting module 202 converts the movement data of the electronic device 2 into the first control signal.

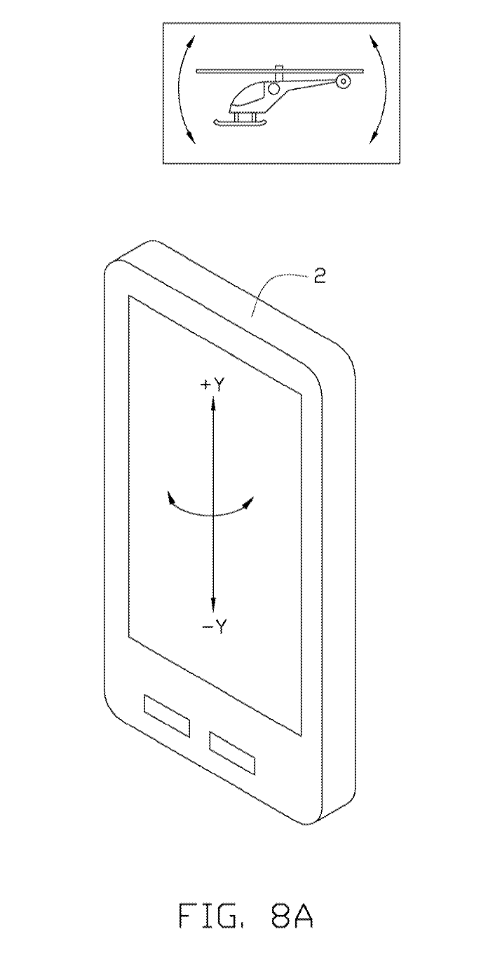

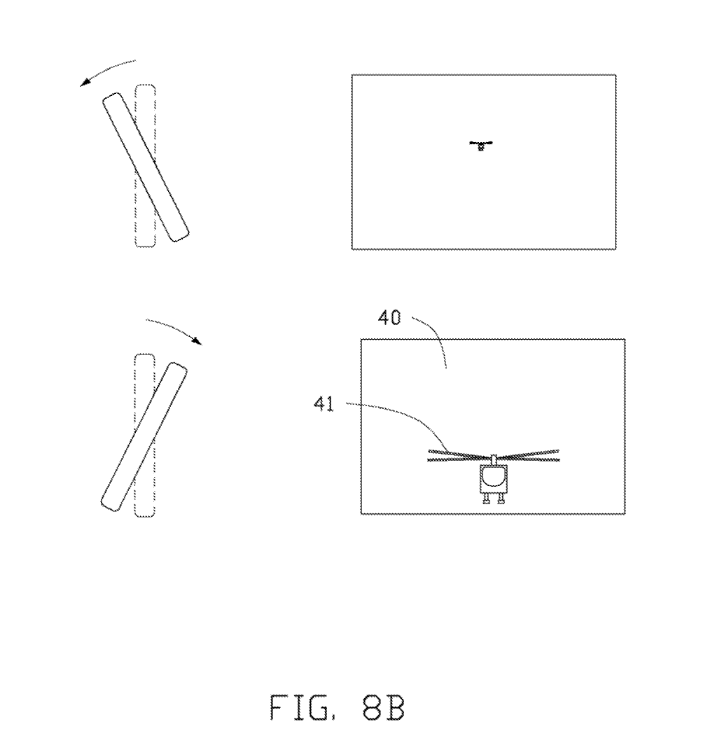

If the electronic device 2 is moved as shown in FIG. 8A, the data converting module 202 converts the movement data of the electronic device 2 into the second control signal. That is to say, if the movement distance in the X-axis of the electronic device 2 is greater than or equal to the first preset value, the movement distance in the Y-axis of the electronic device 2 is less than the second preset value, and the movement distance in the Z-axis of the electronic device 2 is greater than or equal to the third preset value, the data converting module 202 converts the movement data of the electronic device 2 into the second control signal.

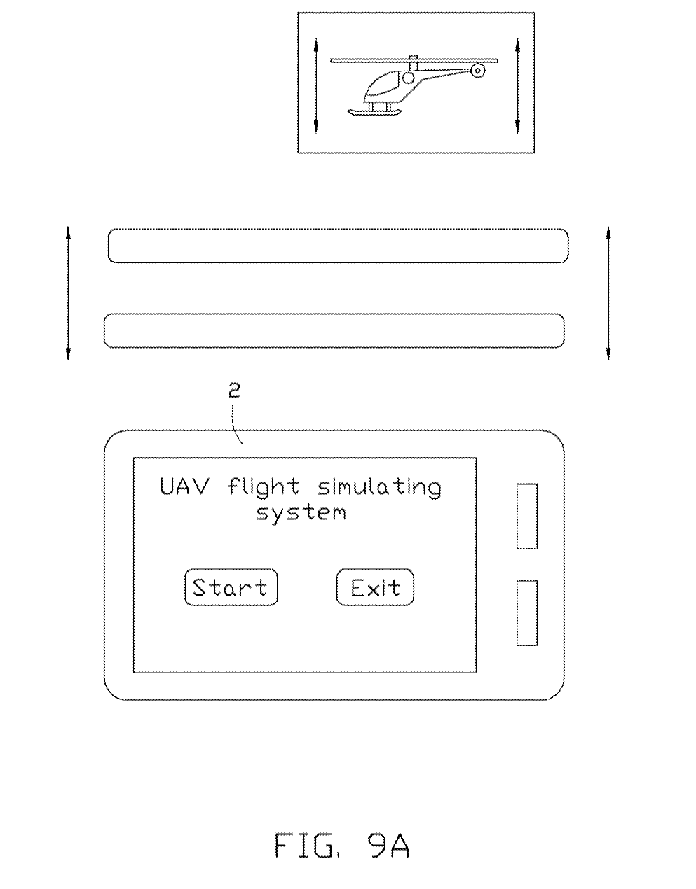

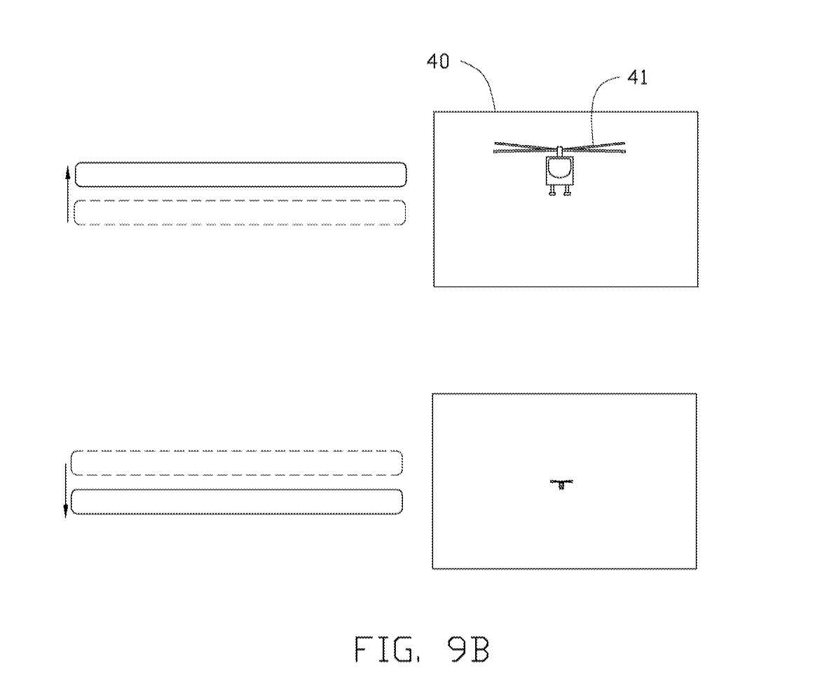

If the electronic device 2 is moved as shown in FIG. 9A, the data converting module 202 converts the movement data of the electronic device 2 into the third control signal. That is to say, if the movement distance in the X-axis of the electronic device 2 is less than the first preset value, the movement distance in the Y-axis of the electronic device 2 is less than the second preset value, and the movement distance in the Z-axis of the electronic device 2 is greater than or equal to the third preset value, the data converting module 202 converts the movement data of the electronic device 2 into the third control signal.

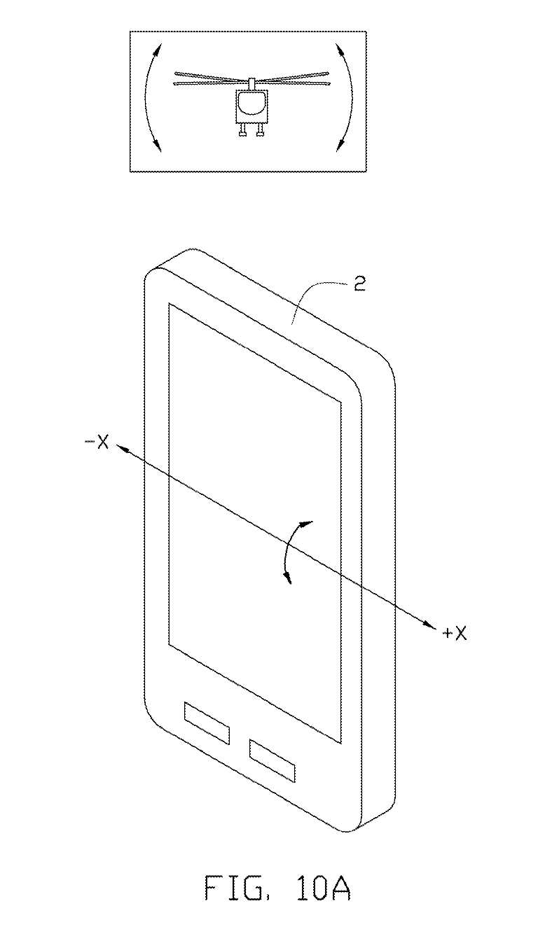

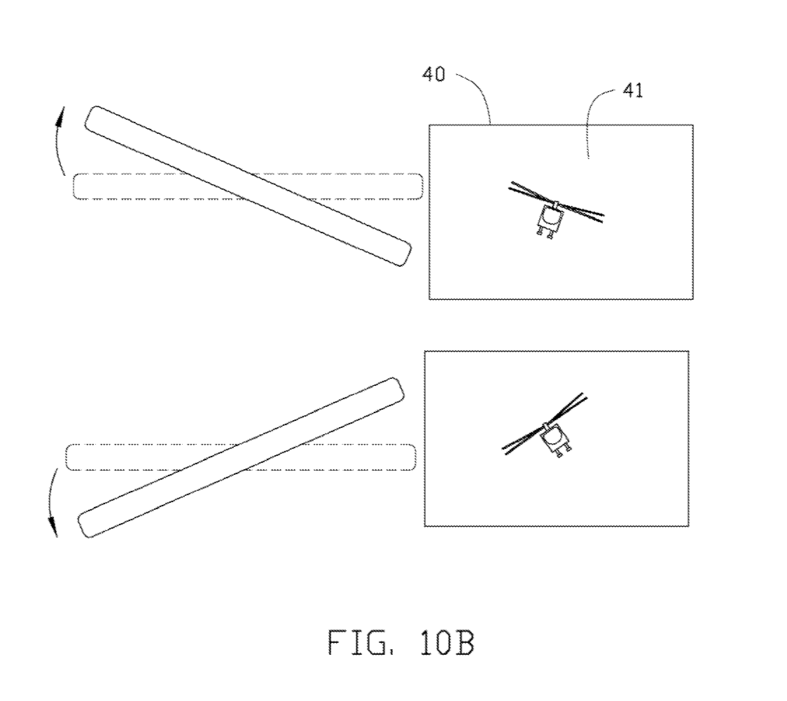

If the electronic device 2 is moved as shown in FIG. 10A, the data converting module 202 converts the movement data of the electronic device 2 into the fourth control signal. That is to say, if the movement distance in the X-axis of the electronic device 2 is less than the first preset value, the movement distance in the Y-axis of the electronic device 2 is greater than or equal to the second preset value, and the movement distance in the Z-axis of the electronic device 2 is greater than or equal to the third preset value, the data converting module 202 converts the movement data of the electronic device 2 into the fourth control signal.

In block S4, the signal adjustment module 203 adjusts the control signals using the physics engine 21 according to the preset environmental parameters of the 3D virtual scene 40.

For example, if the control signal is based on moving the 3D virtual UAV 41 to the left with a speed of ten meters per second (i.e., 10 m/s), the wind speed in the 3D virtual scene 40 is five meters per second (i.e., 5 m/s) towards the right. Then, physics engine 21 adjusts the control signal to move the 3D virtual UAV 41 towards the left in an adjusted speed of five meters per second.

In block S5, the flight simulation module 204 simulates flight operations of UAV using the physics engine 21 by controlling flight statuses of the 3D virtual UAV 41 in the 3D virtual scene 40 according to the adjusted control signals, and displaying the flight statuses of the 3D virtual UAV 41 on the display screen 20. For example, if the electronic device 2 moves one centimeter towards the left, the 3D virtual UAV 41 is moved six centimeters towards the left in the 3D virtual scene 40. More examples of simulating the flight operation of UAV are shown in FIG. 7B, FIG. 8B, FIG. 9B, and FIG. 10B.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for simulating flight operations of an unmanned aerial vehicle (UAV) using an electronic device comprising a processor, the method comprising execution of the steps comprising:
obtaining movement data of the electronic device detected by an accelerator sensor of the electronic device;
converting the movement data of the electronic device into control signals;
adjusting the control signals using a physics engine of the electronic device according to preset environmental parameters of a three dimensional (3D) virtual scene on a display screen of the electronic device; and
simulating flight operations of the UAV using the physics engine by controlling flight statuses of a 3D virtual UAV in the 3D virtual scene according to the adjusted control signals.

2. The method according to claim 1, wherein the movement data of the electronic device comprise movement directions and movement distances of the electronic device based on a 3D coordinate system.

3. The method according to claim 2, wherein the control signals comprise: a first control signal to control lateral motion of a cyclic control of the 3D virtual UAV, a second control signal to control longitudinal motion of the cyclic control of the 3D virtual UAV, a third control signal to control motion of a collective pitch control of the 3D virtual UAV, and a fourth control signal to control motions of anti-torque pedals of the 3D virtual UAV.

4. The method according to claim 2, wherein the step of converting the movement data of the electronic device into control signals comprises:
converting the movement data of the electronic device into a first control signal upon the condition that the movement distance in an X-axis of the electronic device is greater than or equal to a first preset value, the movement distance in a Y-axis of the electronic device is greater than or equal to a second preset value, and the movement distance in an Z-axis of the electronic device is less than a third preset value.

5. The method according to claim 2, wherein the step of converting the movement data of the electronic device into control signals comprises:
converting the movement data of the electronic device into a second control signal upon the condition that the movement distance in the X-axis of the electronic device is greater than or equal to the first preset value, the movement distance in the Y-axis of the electronic device is less than the second preset value, and the movement distance in the Z-axis of the electronic device is greater than or equal to the third preset value.

6. The method according to claim 2, wherein the step of converting the movement data of the electronic device into control signals comprises:
converting the movement data of the electronic device into a third control signal upon the condition that the movement distance in the X-axis of the electronic device is less than the first preset value, the movement distance in the Y-axis of the electronic device is less than the second preset value, and the movement distance in the Z-axis of the electronic device is greater than or equal to the third preset value.

7. The method according to claim 2, wherein the step of converting the movement data of the electronic device into control signals comprises:
converting the movement data of the electronic device into a fourth control signal upon the condition that the movement distance in the X-axis of the electronic device is less than the first preset value, the movement distance in the Y-axis of the electronic device is greater than or equal to the second preset value, and the movement distance in the Z-axis of the electronic device is greater than or equal to the third preset value.

8. An electronic device, comprising:
a display screen;
a storage unit;
at least one processor; and
one or more modules that are stored in the storage unit and are executed by the at least one processor, the one or more modules comprising:
a data obtaining module that obtains movement data of the electronic device detected by an accelerator sensor of the electronic device;
a data converting module that converts the movement data of the electronic device into control signals;
a signal adjustment module that adjusts the control signals using a physics engine of the electronic device according to preset environmental parameters of a three dimensional (3D) virtual scene on the display screen; and
a flight simulation module that simulates flight operations of an unmanned aerial vehicle (UAV) using the physics engine by controlling flight statuses of a 3D virtual UAV in the 3D virtual scene according to the adjusted control signals.

9. The electronic device according to claim 8, wherein the movement data of the electronic device comprise movement directions and movement distances of the electronic device based on a 3D coordinate system.

10. The electronic device according to claim 9, wherein the control signals comprise: a first control signal to control lateral motion of a cyclic control of the 3D virtual UAV, a second control signal to control longitudinal motion of the cyclic control of the 3D virtual UAV, a third control signal to control motion of a collective pitch control of the 3D virtual UAV, and a fourth control signal to control motions of anti-torque pedals of the 3D virtual UAV.

11. The electronic device according to claim 9, wherein the data converting module converts the movement data of the electronic device into control signals comprises:
converting the movement data of the electronic device into a first control signal upon the condition that the movement distance in an X-axis of the electronic device is greater than or equal to a first preset value, the movement distance in a Y-axis of the electronic device is greater than or equal to a second preset value, and the movement distance in an Z-axis of the electronic device is less than a third preset value.

12. The electronic device according to claim 9, wherein the data converting module converts the movement data of the electronic device into control signals comprises:
converting the movement data of the electronic device into a second control signal upon the condition that the movement distance in the X-axis of the electronic device is greater than or equal to the first preset value, the movement distance in the Y-axis of the electronic device is less than the second preset value, and the movement distance in the Z-axis of the electronic device is greater than or equal to the third preset value.

13. The electronic device according to claim 9, wherein the data converting module converts the movement data of the electronic device into control signals comprises:
converting the movement data of the electronic device into a third control signal upon the condition that the movement distance in the X-axis of the electronic device is less than the first preset value, the movement distance in the Y-axis of the electronic device is less than the second preset value, and the movement distance in the Z-axis of the electronic device is greater than or equal to the third preset value.

14. The electronic device according to claim 9, wherein the data converting module converts the movement data of the electronic device into control signals comprises:
converting the movement data of the electronic device into a fourth control signal upon the condition that the movement distance in the X-axis of the electronic device is less than the first preset value, the movement distance in the Y-axis of the electronic device is greater than or equal to the second preset value, and the movement distance in the Z-axis of the electronic device is greater than or equal to the third preset value.

15. A non-transitory storage medium having stored thereon instructions that, when executed by a processor of an electronic device, causes the electronic device to perform a method for simulating flight operations of an unmanned aerial vehicle (UAV) using the electronic device, the method comprising:
obtaining movement data of the electronic device detected by an accelerator sensor of the electronic device;
converting the movement data of the electronic device into control signals;
adjusting the control signals using a physics engine of the electronic device according to preset environmental parameters of a three dimensional (3D) virtual scene on a display screen of the electronic device; and
simulating flight operations of the UAV using the physics engine by controlling flight statuses of a 3D virtual UAV in the 3D virtual scene according to the adjusted control signals.

16. The non-transitory storage medium according to claim 15, wherein the movement data of the electronic device comprise movement directions and movement distances of the electronic device based on a 3D coordinate system.

17. The non-transitory storage medium according to claim 16, wherein the step of converting the movement data of the electronic device into control signals comprises:
converting the movement data of the electronic device into a first control signal upon the condition that the movement distance in an X-axis of the electronic device is greater than or equal to a first preset value, the movement distance in a Y-axis of the electronic device is greater than or equal to a second preset value, and the movement distance in an Z-axis of the electronic device is less than a third preset value.

18. The non-transitory storage medium according to claim 16, wherein the step of converting the movement data of the electronic device into control signals comprises:
converting the movement data of the electronic device into a second control signal upon the condition that the movement distance in the X-axis of the electronic device is greater than or equal to the first preset value, the movement distance in the Y-axis of the electronic device is less than the second preset value, and the movement distance in the Z-axis of the electronic device is greater than or equal to the third preset value.

19. The non-transitory storage medium according to claim 16, wherein the step of converting the movement data of the electronic device into control signals comprises:
converting the movement data of the electronic device into a third control signal upon the condition that the movement distance in the X-axis of the electronic device is less than the first preset value, the movement distance in the Y-axis of the electronic device is less than the second preset value, and the movement distance in the Z-axis of the electronic device is greater than or equal to the third preset value.

20. The non-transitory storage medium according to claim 16, wherein the step of converting the movement data of the electronic device into control signals comprises:
converting the movement data of the electronic device into a fourth control signal upon the condition that the movement distance in the X-axis of the electronic device is less than the first preset value, the movement distance in the Y-axis of the electronic device is greater than or equal to the second preset value, and the movement distance in the Z-axis of the electronic device is greater than or equal to the third preset value.
